(19) United States
(12) Patent Application Publication
(10) Pub. No.: US 2026/0160297 A1
(43) Pub. Date: Jun. 11, 2026

(54) BEARING CAP WITH INTEGRATED LUBRICATION PASSAGE

(71) Applicant: Schaeffler Technologies AG & Co. KG, Herzogenaurach (DE)

(72) Inventors: Christopher Tvaroch, Fairlawn, OH (US); Scott Angel, Marshallville, OH (US)

(73) Assignee: Schaeffler Technologies AG & Co. KG, Herzogenaurach (DE)

(21) Appl. No.: 18/975,202

(22) Filed: Dec. 10, 2024

(51) Int. Cl. F16C 33/66

(52) U.S. Cl. CPC F16C 33/6681

(57) ABSTRACT

A bearing cap includes a bearing support portion arranged for supporting an outer surface of a bearing, and a first mounting lug, integrally formed with the bearing support portion from a same piece of material. The first mounting lug includes a first through hole for receiving a first fastener to mount the bearing cap to a mating component, and a second through hole arranged for directing a lubrication fluid to the bearing. The bearing support portion may include a partial circumferential surface. The second through hole may be orthogonal to the first through hole. The first mounting lug may include a first planar surface, and the first through hole may extend through the first planar surface.

### TECHNICAL FIELD

The present disclosure relates generally to a bearing cap, and more specifically to a bearing cap with a lubrication passage.

### BACKGROUND

Bearing covers with oil holes are known from Chinese Utility Model No. CN 210013948 U titled “ [symbol] [symbol] ” [DOUBLE ROW SLIDING BEARING] assigned to ZHUJI JIYANG SLIDING BEARING CO LTD, for example.

### SUMMARY

Example embodiments broadly comprise a bearing cap including a bearing support portion arranged for supporting an outer surface of a bearing, and a first mounting lug, integrally formed with the bearing support portion from a same piece of material. The first mounting lug includes a first through hole for receiving a first fastener to mount the bearing cap to a mating component, and a second through hole arranged for directing a lubrication fluid to the bearing. In an example embodiment, the bearing support portion includes a partial circumferential surface. In an example embodiment, the second through hole is orthogonal to the first through hole. In an example embodiment, the first mounting lug includes a first planar surface, and the first through hole extends through the first planar surface.

In some example embodiments, the first mounting lug also includes a first recessed portion forming a lubrication fluid reservoir, and the second through hole extends from the first recessed portion through the bearing support portion. In some example embodiments, the first recessed portion includes a tapered surface, and the second through hole extends through the tapered surface. In an example embodiment, the tapered surface slopes towards the second through hole to direct the lubrication fluid towards the second through hole. In an example embodiment, the first mounting lug includes a first planar surface, the first through hole extends through the first planar surface, the tapered surface includes a planar portion, and the planar portion is orthogonal to the first planar surface. In an example embodiment, the first through hole is entirely separate from the second through hole. In an example embodiment, a diameter of the first through hole is at least four times (4×) greater than a diameter of the second through hole.

In some example embodiments, the first mounting lug also includes a bottom face arranged for contacting the mating component. The bottom face includes a geometrical centerline, the first through hole extends through the geometrical centerline, and the second through hole is offset from the geometrical centerline. In an example embodiment, the second through hole includes a centerline extending parallel to the geometrical centerline. In an example embodiment, the first through hole extends through the bottom face. In some example embodiments, the first mounting lug also includes a top face arranged parallel to the bottom face, and the first through hole extends through the top face. In an example embodiment, the second through hole does not extend through the top face or the bottom face.

In some example embodiments, the bearing cap also includes a second mounting lug integrally formed with the bearing support portion from the same piece of material. The second mounting lug includes a third through hole for receiving a second fastener to mount the bearing cap to the mating component. In an example embodiment, the bearing support portion is arranged between the first mounting lug and the second mounting lug. In an example embodiment, the bearing support portion includes a partial circumferential surface having a center, and the first mounting lug and the second mounting lug are symmetrically arranged about the center. In an example embodiment, the second mounting lug also includes a second recessed portion.

### BRIEF DESCRIPTION OF THE DRAWINGS

FIG. 1 illustrates a perspective view of a bearing cap according to an example embodiment.

FIG. 2 illustrates an end view of the bearing cap of FIG. 1.

FIG. 3 illustrates a cross-sectional view of the bearing cap of FIG. 1 taken generally along line 3-3 in FIG. 2.

FIG. 4 illustrates a cross-sectional view of the bearing cap of FIG. 1 taken generally along line 4-4 in FIG. 2.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

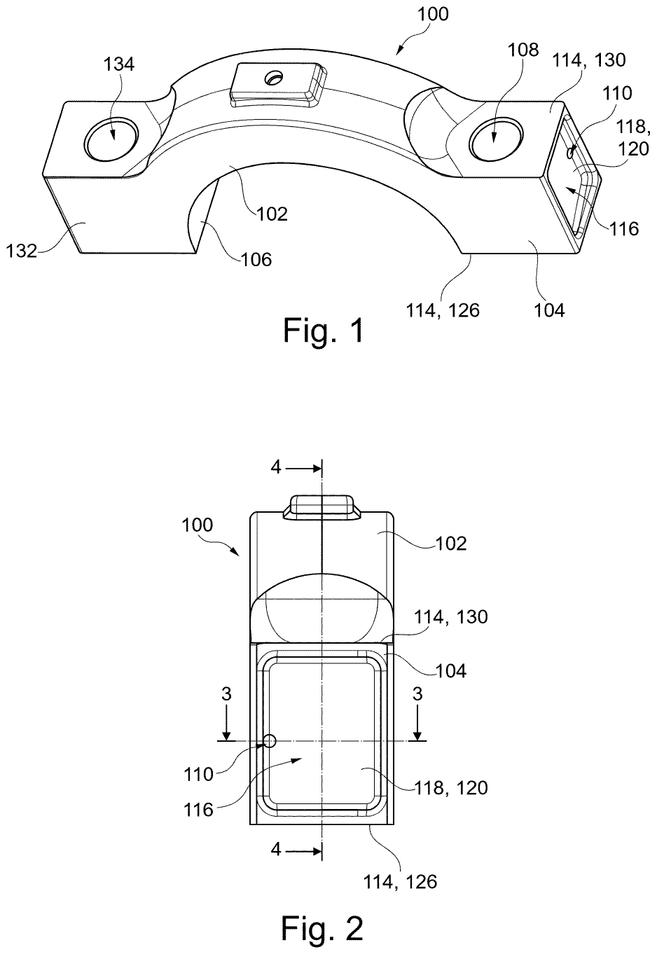

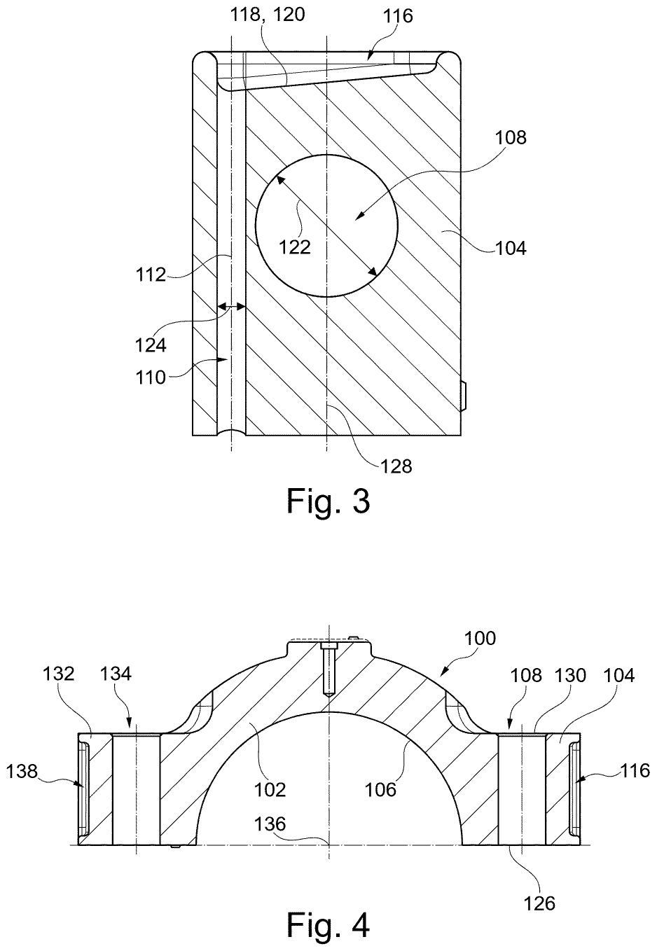

The following description is made with reference to FIGS. 1-4. FIG. 1 illustrates a perspective view of bearing cap 100 according to an example embodiment. FIG. 2 illustrates an end view of bearing cap 100 of FIG. 1. FIG. 3 illustrates a cross-sectional view of bearing cap 100 of FIG. 1 taken generally along line 3-3 in FIG. 2. FIG. 4 illustrates a cross-sectional view of bearing cap 100 of FIG. 1 taken generally along line 4-4 in FIG. 2.

Bearing cap 100 includes bearing support portion 102 arranged for supporting an outer surface of a bearing (not shown) and mounting lug 104, integrally formed with the bearing support portion from a same piece of material. That is, the bearing cap may be arranged in an axle housing (not shown) for fixing bearings (not shown) that rotatably mount a differential housing (not shown) relative to the axle housing. The bearings may be tapered roller bearings or ball bearings, for example. A mating portion of the bearing support may be formed in the axle housing, for example, and the bearing cap may be secured to the axle housing to fix an outer race of the bearing, for example. Bearing support portion 102 includes partial circumferential surface 106 arranged to support the bearing.

Mounting lug 104 includes through hole 108 for receiving a fastener (not shown) to mount the bearing cap to a mating component (e.g., the axle housing), and through hole 110 arranged for directing a lubrication fluid to the bearing as described below. As shown best in FIG. 3, for example, through hole 110 is orthogonal to through hole 108. That is, hole 108 extends into the page and hole 110 extends vertically, as indicated by centerline 112, for example. Mounting lug 104 includes planar surface 114 and through hole 108 extends through planar surface 114.

Mounting lug 104 also includes recessed portion 116 forming a lubrication fluid reservoir through hole 110 extends from recessed portion 116 through bearing support portion 102. Therefore, when installed in the axle housing discussed above, the recessed portion is arranged to collect the lubrication fluid splashed about by gears and other components in the axle housing and direct the fluid to the bearing contained in the bearing support portion. This allows sufficient lubrication for the bearing even though the bearing may not be operating in a pool of lubrication fluid (e.g., oil). Recessed portion 116 includes tapered surface 118 and through hole 110 extends through tapered surface 118. Tapered surface 118 slopes towards through hole 110 to direct the lubrication fluid towards through hole 110, thus maximizing the lubrication fluid directed to the bearing.

Tapered surface 118 includes planar portion 120 and the planar portion is orthogonal to planar surface 114. That is, as shown in FIG. 3, for example, the planar portion extends in and out of the page, while planer surface 114, parallel to the sectioned surface shown, is parallel to the page. As also shown in FIG. 3, for example, through hole 108 is entirely separate from through hole 110. In other words, the two holes do not intersect. Diameter 122 of through hole 108 is at least four times (4×) greater than diameter 124 of through hole 110.

Mounting lug 104 also includes bottom face 126 arranged for contacting the mating component as described above, and bottom face 126 includes geometrical centerline 128 (ref. FIG. 3). Hole 108 extends through the geometrical centerline and hole 110 is offset from the geometrical centerline. Centerline 112 extending parallel to geometrical centerline 128. Through hole 108 extends through the bottom face. Mounting lug 104 also includes top face 130 arranged parallel to the bottom face, and through hole 108 extends through the top face. Planar surface 114 described above may be the top face or the bottom face, for example. Through hole 110 does not extend through the top face or the bottom face.

Bearing cap 100 also includes mounting lug 132 integrally formed with the bearing support portion from the same piece of material. Mounting lug 132 includes through hole 134 for receiving a second fastener (not shown) to mount the bearing cap to the mating component. Bearing support portion 102 is arranged between the mounting lugs 104 and 132. Partial circumferential surface 106 includes center 136 and mounting lugs 104 and 132 are symmetrically arranged about the center. That is, the lugs have a common shape and are arranged equidistant from either side of center 136. Mounting lug 132 also includes recessed portion 138, similar to recessed portion 116 described above. Lug 132 may also include a through hole (not shown), similar to through hole 110 described above, so that the bearing cap can be oriented in either direction (e.g., either lug facing upwards) and still provide lubricating fluid to the bearing.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Bearing cap
102 Bearing support portion
104 Mounting lug (first)
106 Partial circumferential surface
108 Through hole (first)
110 Through hole (second)
112 Centerline (second through hole)
114 Planar surface (first, first mounting lug)
116 Recessed portion (first, first lug)
118 Tapered surface (first, first recessed portion)
120 Planar portion (tapered surface)
122 Diameter (first through hole)
124 Diameter (second through hole)
126 Bottom face (first mounting lug)
128 Geometrical centerline (bottom face)
130 Top face (first mounting lug)
132 Mounting lug (second)
134 Through hole (third)
136 Center (partial circumferential surface)
138 Recessed portion (second, second lug)

What is claimed is:

1. A bearing cap, comprising:
a bearing support portion arranged for supporting an outer surface of a bearing;
a first mounting lug, integrally formed with the bearing support portion from a same piece of material, the first mounting lug comprising:
a first through hole for receiving a first fastener to mount the bearing cap to a mating component; and
a second through hole arranged for directing a lubrication fluid to the bearing.

2. The bearing cap of claim 1, wherein the bearing support portion comprises a partial circumferential surface.

3. The bearing cap of claim 1, wherein the second through hole is orthogonal to the first through hole.

4. The bearing cap of claim 1, wherein:
the first mounting lug comprises a first planar surface; and
the first through hole extends through the first planar surface.

5. The bearing cap of claim 1, wherein:
the first mounting lug further comprises a first recessed portion forming a lubrication fluid reservoir; and
the second through hole extends from the first recessed portion through the bearing support portion.

6. The bearing cap of claim 5, wherein:
the first recessed portion comprises a tapered surface; and
the second through hole extends through the tapered surface.

7. The bearing cap of claim 6, wherein the tapered surface slopes towards the second through hole to direct the lubrication fluid towards the second through hole.

8. The bearing cap of claim 6, wherein:
the first mounting lug comprises a first planar surface;
the first through hole extends through the first planar surface;
the tapered surface comprises a planar portion; and
the planar portion is orthogonal to the first planar surface.

9. The bearing cap of claim 1, wherein the first through hole is entirely separate from the second through hole.

10. The bearing cap of claim 1, wherein a diameter of the first through hole is at least four times (4×) greater than a diameter of the second through hole.

11. The bearing cap of claim 1, wherein:
the first mounting lug further comprises a bottom face arranged for contacting the mating component;
the bottom face comprises a geometrical centerline;
the first through hole extends through the geometrical centerline; and
the second through hole is offset from the geometrical centerline.

12. The bearing cap of claim 11, wherein the second through hole comprises a centerline extending parallel to the geometrical centerline.

13. The bearing cap of claim 11, wherein the first through hole extends through the bottom face.

14. The bearing cap of claim 11, wherein:
the first mounting lug further comprises a top face arranged parallel to the bottom face; and
the first through hole extends through the top face.

15. The bearing cap of claim 14, wherein the second through hole does not extend through the top face or the bottom face.

16. The bearing cap of claim 1, further comprising a second mounting lug integrally formed with the bearing support portion from the same piece of material, the second mounting lug comprising a third through hole for receiving a second fastener to mount the bearing cap to the mating component.

17. The bearing cap of claim 16, wherein the bearing support portion is arranged between the first mounting lug and the second mounting lug.

18. The bearing cap of claim 16, wherein:
the bearing support portion comprises a partial circumferential surface having a center; and
the first mounting lug and the second mounting lug are symmetrically arranged about the center.

19. The bearing cap of claim 16, wherein the second mounting lug further comprises a second recessed portion.
